(19) United States
(12) Patent Application Publication
(10) Pub. No.: US 2013/0149659 A1
(43) Pub. Date: Jun. 13, 2013

(54) Orthodontic Device for Use in Conjunction with a Temporary Anchor Device and Method for Using the Same

(71) Applicant: Bella Shen Garnett, San Francisco, CA (US)

(72) Inventor: Bella Shen Garnett, San Francisco, CA (US)

(21) Appl. No.: 13/315,693

(22) Filed: Dec. 9, 2011

(51) Int. Cl. A61C 7/22

(52) U.S. Cl. 433/20; 433/24

(57) ABSTRACT

An apparatus for applying an orthodontic force to a tooth of a patient in combination with an orthodontic appliance and a temporary anchor device (TAD) for coupling to bony oral tissue of the patient. The device includes a wire having a proximal end and a distal end, an adjustable stop coupled to the wire at a selectable position between the proximal and distal ends, and a spring. The proximal end of the wire is configured to be coupled to the TAD and the distal end of the wire is configured to be coupled to the orthodontic appliance disposed on the tooth of the patient. The spring is disposed between the orthodontic appliance and the adjustable stop in order to apply the orthodontic force to the tooth. The proximal end of the wire comprises a hook shape which is configured to be coupled to the TAD.

### BACKGROUND

1. Field of the Technology

The disclosure relates to the field of orthodontic devices, specifically an orthodontic device capable of being coupled to a temporary anchor device (TAD) for moving the teeth of a patient.

2. Description of the Prior Art

Over time, there has been innumerable orthodontic devices which have been used to shift, move, or otherwise guide the teeth of a patient from an initial position to a second desired position. These devices have ranged from standard braces and retainers to appliances which are custom designed to correct a patient's overbite, for example.

One such dental appliance commonly used is a distalizer spring or arch which uses a spring force to slowly push a molar backwards or distally in the patient's jaw. Many distalizer springs are coupled to a band which is attached to the molar which is to be moved, while the opposing end of the distalizer spring is coupled to an arch which is wrapped around the anterior teeth. The distalizer spring uses the anterior teeth as an anchor point to provide a force which pushes the molar into its desired position. While this particular apparatus and method has proven successful in some situations, it is not ideal for patients who do not require their anterior moved. Additional orthodontic devices which employ various large springs and elastics have been used, however many of these devices require a high degree of patient compliance in maintaining the device, thus decreasing its efficiency and overall effectiveness.

What is needed is an orthodontic device and method which provides a means for moving the molar of a patient into a desired position without causing any of the patient's other teeth to move and while at the same time not requiring the patient to maintain the device, thus increasing the overall effectiveness of the device.

### BRIEF SUMMARY

The invention comprises an apparatus for applying an orthodontic force to a tooth of a patient in combination with an orthodontic appliance and a temporary anchor device (TAD) for coupling to bony oral tissue of the patient. The device includes a wire having a proximal end and a distal end, an adjustable stop coupled to the wire at a selectable position between the proximal and distal ends, and a spring. The proximal end of the wire is configured to be coupled to the temporary anchor device (TAD) and the distal end of the wire is configured to be coupled to the orthodontic appliance disposed on the tooth of the patient, which tooth is to be moved. The spring is disposed between the orthodontic appliance and the adjustable stop in order to apply the orthodontic force to the tooth. The proximal end of the wire comprises a hook shape which is configured to be coupled to the TAD.

In one embodiment, the adjustable stop is an omega adjustable stop. In a separate embodiment, the adjustable stop is an adjustable screw stop.

In another preferred embodiment, the orthodontic appliance which is coupled to the distal end of the wire is a band. The proximal end of the wire is coupled to the TAD by means of an epoxy.

In yet another embodiment, the adjustable stop is coupled to the wire at the selected position according to an orthodontic treatment to be given to the patient.

The invention also comprises a method for applying an orthodontic force to a tooth of a patient. The method includes installing an orthodontic appliance to the tooth of the patient, which tooth is to be moved, coupling a proximal end of a wire to an anchor point independent of any tooth, coupling a distal end of the wire to the orthodontic appliance, compressing a spring disposed between the anchor point and orthodontic appliance, and then applying the orthodontic force on the orthodontic appliance.

In one embodiment, the method further includes implanting a temporary anchor device (TAD) within the oral cavity of the patient to provide the anchor point. The proximal end of the wire is then coupled to the TAD.

In another embodiment, the method further includes coupling an adjustable stop to the wire between the anchor point and the orthodontic appliance. Specifically, compressing the spring is this embodiment includes concentrically disposing the spring on the wire and compressing the spring between the adjustable stop and the orthodontic appliance. The adjustable stop is coupled to the wire in proximity to the orthodontic device according to a predetermined amount of force that is to be applied to the tooth of the patient, which tooth is to be moved.

In another embodiment, the method step of installing an orthodontic appliance comprises installing a band on the tooth of the patient, which tooth is to be moved.

In yet another embodiment, the method further includes shaping the proximal end of the wire away from the proximity of the patient's anterior teeth to couple with the anchor point.

The invention further provides for a kit for applying an orthodontic force to a selected tooth of a patient. The kit includes an orthodontic appliance adapted for coupling to the selected tooth to be orthodontically moved, a temporary anchor device (TAD) configured for coupling to oral bony tissue of the patient, and a wire having a proximal end and a distal end, the proximal end of the wire configured for coupling to the temporary anchor device (TAD) and the distal end of the wire configured for coupling to the orthodontic appliance. An adjustable stop is coupled to the wire at a user selected position between the proximal and distal ends. Also, a spring is disposed between the orthodontic appliance and the adjustable stop for applying the orthodontic force to the selected tooth.

In one embodiment, the proximal end of the wire in the kit comprises a hook shape which is configured to be coupled to the TAD.

In another embodiment, the adjustable stop of the kit is an omega adjustable stop, while in a separate embodiment, the adjustable stop is an adjustable screw stop.

Finally, the adjustable stop of the kit is coupled to the wire at the user selected position according to an orthodontic treatment to be given to the patient by a user.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 is a side plan view of the current orthodontic device when coupled to a band.

FIG. 2 is a perspective view of a temporary anchor device (TAD) used in conjunction with the orthodontic device seen in FIG. 1.

FIG. 3A is a side view of the orthodontic device when implanted on the right first molar of a patient.

FIG. 3B is a frontal view of two orthodontic devices when implanted on both the right and left first molars of a patient.

FIG. 3C is a side view of the orthodontic device when implanted on the left first molar of a patient.

FIG. 4 is a side plan view of an alternative embodiment of the orthodontic device seen in FIG. 1.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

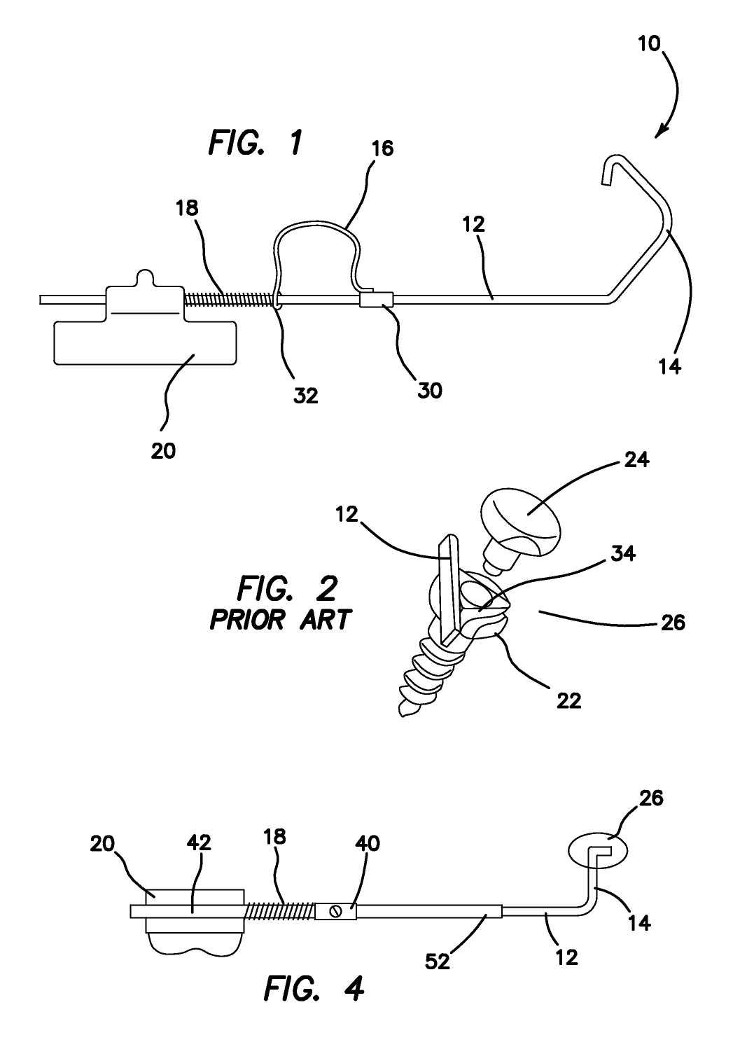

A first embodiment of the current orthodontic device may be seen in FIG. 1 and is generally denoted with reference numeral 10. The orthodontic device 10 comprises a wire 12 with a proximal end 14 that is substantially hooked shaped. Coupled to the wire 12 is an omega adjustable stop 16. The adjustable stop 16 is coupled to the wire 12 via the proximal foot 30 and distal foot 32 by means known in the art according to the specific orthodontic treatment to be done to the patient. The orthodontic device 10 also comprises a spring 18 which is disposed concentrically about the wire 12 and distal to the adjustable stop 16.

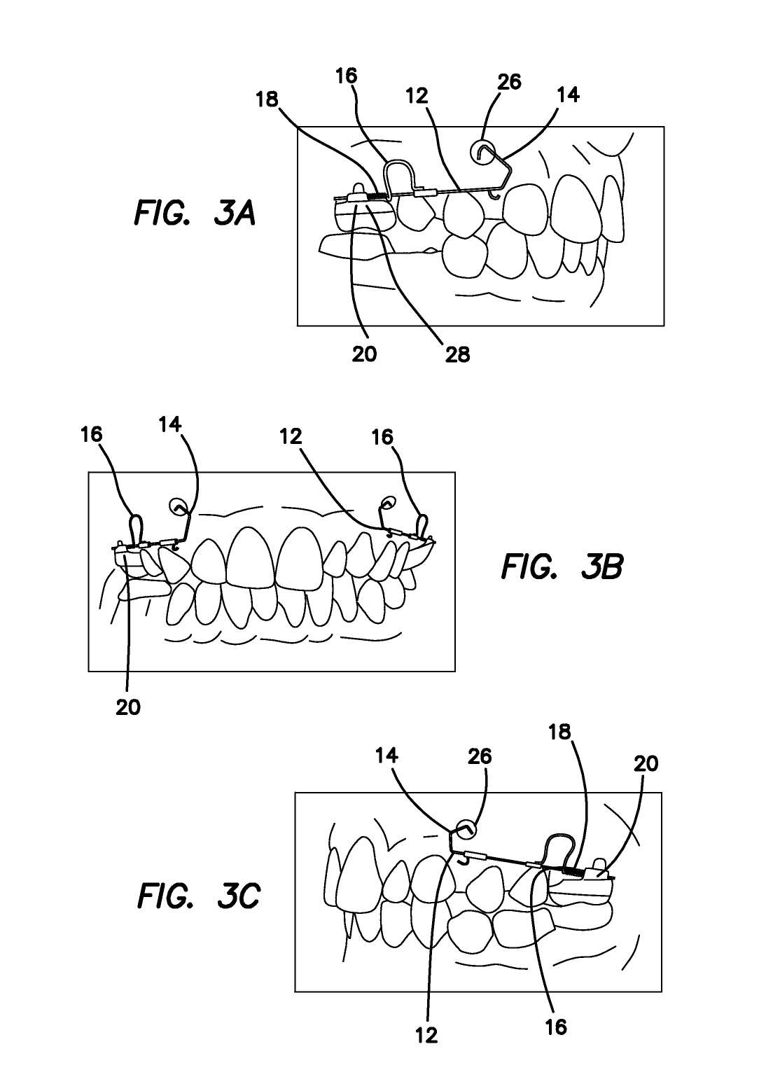

In one particular embodiment, the orthodontic device 10 is used in conjunction with a temporary anchor device (TAD) 26 as seen in FIGS. 2-3C. A TAD 26 is a well known orthodontic apparatus used in a variety of applications where an anchor point within the mouth of a patient is required. Briefly, as seen in FIG. 2, a typical TAD 26 comprises a screw 22 which is tapped into the patient, typically along the gum line or on the roof of the mouth. The screw 22 itself comprises a plurality of apertures 34 defined in its top surface for accommodating a variety of orthodontic structures including the wire 12 as seen in FIG. 2. The wire 12 may be secured to the screw 22 by means of a locking cap 24, or by a dental resin or an epoxy well known in the art which is used to seal the wire 12 within the TAD 26.

To implant the orthodontic device 10 into the mouth of a patient, the patient's teeth are first carefully examined and measured. An orthodontic prescription is then generated by an orthodontist or dental professional. A TAD 26 is then implanted into the mouth of the patient according to the measurements and prescribed treatment that is to be applied to the patient. In FIGS. 3A-3C, the TAD 26 is seen as being implanted into the upper buccal gum line, however this is meant to be for illustrative purposes only. It is to be expressly understood that the TAD 26 may be placed anywhere within the patient's oral cavity without departing from the original spirit and scope of the invention.

After placement of the TAD 26, a band 20 is inserted onto the tooth that is to be moved, i.e. the first molar 28 as seen in FIG. 3A. While the first molar 28 is seen with the coupled band 20, it is to be expressly understood that different teeth other than what is shown may be moved by the current orthodontic device 10. Furthermore, a band 20 is shown as being coupled to the molar 28, however this is meant to be for illustrative purposes only. Similar orthodontic appliances now known or later devised may also be used in conjunction with the current orthodontic device 10 without departing from the original spirit and scope of the invention.

As seen in FIGS. 3A-3C, the proximal end 14 of the orthodontic device 12 is inserted into the implanted TAD 26 and is sealed with epoxy or glue as is well known in the art. The substantially hooked shaped proximal end 14 is configured to curl away from the anterior teeth of the patient and remain in a position that is unobtrusive to the patient. The omega adjustable stop 16 is then coupled to the wire 12 at a predetermined location according to the prescribed treatment for the patient. The adjustable stop 16 may be coupled to the wire 12 by a pair of pliers, a screw wrench, or other similar means now known or later devised for orthodontic procedures. The spring 18 is then slid distally over the wire 12. Finally, the distal end of the wire 12 is threaded through and coupled to the band 20 or other orthodontic appliance with the spring 18 disposed between the band 20 and the adjustable stop 16.

With the proximal end 14 of the wire 12 firmly anchored to the TAD 26 and the spring 18 in a compressed state between the band 20 and the adjustable stop 16, the spring 18 provides a distally directed force on the band 20, forcing it and the tooth 28 it is coupled to slowly move in a desired direction. Because the TAD 26 provides a stable anchor point for the spring 18, no orthodontic forces are applied to the anterior teeth, thus focusing all movement onto the desired tooth 28. The length of the wire 12 and position of the adjustable stop 16 determine the degree in which the spring 18 is compressed between the band 20 and the adjustable stop 16. The closer the adjustable stop 16 is disposed to the band 20, the greater the spring 18 will be compressed and thus the greater the force that will be applied to the band 20. It is in this fashion therefore that the orthodontist or dental professional may customize the treatment given to the patient according to their specific needs.

It is to be expressly understood however that the adjustable stop 16 does not need to be an omega adjustable stop, but rather may be another orthodontic device now known or later devised. For example as seen in FIG. 4, the device 10 comprises a wire tube 52 and an adjustable screw stop 40 which is used to adjustably configure the wire 12 and the spring 18 to provide the proper orthodontic forces. To adjust the wire 12 to the desired length, the wire 12 and the screw stop 40 are slid either distally or proximally through the wire tube 52 until the desired length is achieved. The screw stop 40 is then tightened with an allen wrench or other equivalent means, thus locking the wire 12 to the wire tube 52 and fixing the level compression force provided by the spring 18. Using the screw stop 40, the compression force provided by the spring 18 may be controlled with a high degree of specificity. The device 10 then operates in the same manner as described above. Also in this embodiment, the band 20 also comprises a bracket tube 42 for accommodating the distal end of the wire 12.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

We claim:

1. An apparatus for applying an orthodontic force to a tooth of a patient in combination with an orthodontic appliance and a temporary anchor device (TAD) for coupling to bony oral tissue of the patient comprising:
a wire having a proximal end and a distal end;
an adjustable stop coupled to the wire at a selectable position between the proximal and distal ends; and
a spring,
wherein the proximal end of the wire is configured to be coupled to the temporary anchor device (TAD) and the distal end of the wire is configured to be coupled to the orthodontic appliance disposed on the tooth of the patient, which tooth is to be moved, the spring being disposed between the orthodontic appliance and the adjustable stop for applying the orthodontic force to the tooth.

2. The apparatus of claim 1 where the proximal end of the wire comprises a hook shape which is configured to be coupled to the TAD.

3. The apparatus of claim 1 where the adjustable stop is an omega adjustable stop.

4. The apparatus of claim 1 where the orthodontic appliance coupled to the distal end of the wire is a band.

5. The apparatus of claim 1 where the adjustable stop is an adjustable screw stop.

6. The apparatus of claim 1 where the proximal end of the wire is coupled to the TAD by means of an epoxy.

7. The apparatus of claim 1 where the adjustable stop is coupled to the wire at the selected position according to an orthodontic treatment to be given to the patient.

8. A method for applying an orthodontic force to a tooth of a patient comprising:
installing an orthodontic appliance to the tooth of the patient, which tooth is to be moved;
coupling a proximal end of a wire to an anchor point independent of any tooth;
coupling a distal end of the wire to the orthodontic appliance;
compressing a spring disposed between the anchor point and orthodontic appliance; and
applying the orthodontic force on the orthodontic appliance.

9. The method of claim 8 further comprising implanting a temporary anchor device (TAD) within the oral cavity of the patient to provide the anchor point.

10. The method of claim 9 where coupling the proximal end of the wire to the anchor point comprises coupling the proximal end of the wire to the TAD.

11. The method of claim 8 further comprising coupling an adjustable stop to the wire between the anchor point and the orthodontic appliance.

12. The method of claim 11 where compressing a spring disposed between the anchor point and orthodontic appliance further comprises concentrically disposing the spring on the wire and compressing the spring between the adjustable stop and the orthodontic appliance.

13. The method of claim 8 where installing an orthodontic appliance comprises installing a band on the tooth of the patient, which tooth is to be moved.

14. The method of claim 8 further comprising shaping the proximal end of the wire away from the proximity of the patient's anterior teeth to couple with the anchor point.

15. The method of claim 12 where compressing the spring between the adjustable stop and the orthodontic appliance further comprises coupling the adjustable stop to the wire in proximity to the orthodontic device according to a predetermined amount of force that is to be applied to the tooth of the patient, which tooth is to be moved.

16. A kit for applying an orthodontic force to a selected tooth of a patient comprising:
an orthodontic appliance adapted for coupling to the selected tooth to be orthodontically moved;
a temporary anchor device (TAD) configured for coupling to oral bony tissue of the patient;
a wire having a proximal end and a distal end, the proximal end of the wire configured for coupling to the temporary anchor device (TAD) and the distal end of the wire configured for coupling to the orthodontic appliance;
an adjustable stop coupled to the wire at a user selected position between the proximal and distal ends; and
a spring disposed between the orthodontic appliance and the adjustable stop for applying the orthodontic force to the selected tooth.

17. The kit of claim 16 where the proximal end of the wire comprises a hook shape which is configured to be coupled to the TAD.

18. The kit of claim 16 where the adjustable stop is an omega adjustable stop.

19. The kit of claim 16 where the adjustable stop is an adjustable screw stop.

20. The kit of claim 16 where the adjustable stop is coupled to the wire at the user selected position according to an orthodontic treatment to be given to the patient by a user.
